(19) United States
(12) Patent Application Publication
(10) Pub. No.: US 2016/0294575 A1
(43) Pub. Date: Oct. 6, 2016

(54) System, Apparatus, and Method for Automatically Configuring Application Terminals in Home Network

(71) Applicant: HUAWEI TECHNOLOGIES CO.,LTD., Shenzhen (CN)

(72) Inventors: Zhiming Ding, Shenzhen (CN); Huangwei Wu, Shenzhen (CN)

(73) Assignee: HUAWEI TECHNOLOGIES CO.,LTD., Shenzhen (CN)

(21) Appl. No.: 15/180,990

(22) Filed: Jun. 13, 2016

Related U.S. Application Data
(63) Continuation of application No. 12/535,167, filed on Aug. 4, 2009.
Application No. 12/535,167 is a continuation-in-part of application No. PCT/CN2008/070198, filed on Jan. 28, 2008.

(30) Foreign Application Priority Data
Feb. 16, 2007 (CN) 200710079297.5

(51) Int. Cl. H04L 12/28; H04L 12/24; H04L 12/66; H04L 29/12

(52) U.S. Cl. CPC H04L 12/2834; H04L 61/2015; H04L 41/0803; H04L 12/66

(57) ABSTRACT

A system, apparatus, and method for automatically configuring application terminals in a home network are provided. The method includes the following steps: A method for automatically configuring an application terminal in a home network, including: exchanging, by an application terminal, information with a home gateway to obtain an address of a Gateway Automatic Configuration Server (GACS) which is different from the address of home gateway; and sending, by the application terminal, a configuration request to the GACS, based on the obtained address of the GACS; obtaining, by the application terminal, an address of a Terminal Automatic Configuration Server (TACS) GACS; sending, by the application terminal, the configuration request to the TACS according to the obtained address of the TACS; and obtaining, by the application terminal, configuration information from the TACS for automatic configuration.

### CROSS-REFERENCE TO RELATED APPLICATIONS

This application is a continuation of U.S. patent application Ser. No. 12/535,167, filed on Aug. 04, 2009, which is a continuation in part of International Application No. PCT/CN2008/070198, filed on Jan. 28, 2008, which claims priority to Chinese Patent Application No. 200710079297.5, filed on Feb. 16, 2007, The afore-mentioned patent applications are hereby incorporated by reference in their entireties.

### FIELD OF THE INVENTION

The present invention relates to the network communication field, and in particular, to a system, apparatus, and method for automatically configuring application terminals in a home network.

### BACKGROUND OF THE INVENTION

At present, IP-based applications such as Internet Protocol Television (IPTV) and Voice over IP (VoIP) are fast developing and will gradually replace dedicated network applications such as cable TV and Public Switched Telephone Network (PSTN) phone. IP application terminals can support IP-based applications only after being configured. For example, the IP address or Universal Resource Locator (URL) of the application server and the protocol used should be configured. On the one hand, the cost for operators/service providers (SPs) to manually configure each IP application terminal is high. On the other hand, it is unreasonable to let users configure IP application terminals. Therefore, it is urgent to implement automatic configuration of IP application terminals.

In the prior art, the Customer Premises Equipment (CPE), such as the home gateway, is used to send a Dynamic Host Configuration Protocol (DHCP) Request message that carries the device identifier in a DHCP option to the DHCP server of an operator. The DHCP server finds the URL of the Automatic Configuration Server (ACS) of the CPE according to the device identifier and then sends a DHCP ACK message that carries the URL of the ACS in a DHCP option to the CPE. In this way, the CPE obtains the URL information of the ACS. In addition, the CPE customized by an operator can be pre-configured with the URL of the operator's ACS before delivery. The CPE accesses the ACS according to the URL of the ACS to obtain the corresponding configuration file. Then the CPE is configured automatically according to the configuration file.

DHCP uses plain texts. Therefore, the URL of the ACS may be easily intercepted when being obtained through DHCP, thus affecting subsequent automatic configuration. Therefore, it is not recommended that the CPE should obtain the URL of the ACS through DHCP. Before a method for obtaining the URL of the ACS securely is available, it is recommended to pre-configure the URL of the ACS for the device before delivery or to manually configure the URL of the ACS. This, however, affects the retail of the CPE.

In actual applications, the CPE can obtain the URL of the ACS through the Point-to-Point Protocol over Ethernet (PPPoE) instead of through DHCP. When PPPoE is used, however, proper regulations need to be made.

The application terminals connected to the home gateway can also use the preceding technical solution to implement automatic configuration. For example, an application terminal sends a DHCP Request message or a PPPoE Request message to the home gateway to obtain the URL of the Terminal Automatic Configuration Server (TACS) from the DHCP server or the PPPoE server through the DHCP Proxy or DHCP Relay function of the home gateway or through the transparent transmission capability of the home gateway. After receiving the URL of the TACS, the home gateway sends it to the application terminal in the same way.

When implementing the present invention, the inventor finds that it is insecure to use DHCP to automatically configure application terminals in the existing technical solution because DHCP uses plain texts. Using PPPoE to automatically configure application terminals may increase the complexity of the application terminal software because PPPoE supports identity authentication.

### SUMMARY OF THE INVENTION

Embodiments of the present invention provide a system, apparatus, and method for automatically configuring application terminals in a home network to ensure that application terminals can securely obtain the URL of an ACS from a public network without increasing the complexity of the application terminal software. Thus, the application terminals in the home network can be automatically and securely configured.

The objective of the present invention is achieved through the following technical solution:

An embodiment of the present invention provides a system for automatically configuring application terminals in a home network. The system includes an application terminal, a home gateway, and a Gateway Automatic Configuration Server (GACS).

The application terminal is adapted to: obtain address information of the GACS through the home gateway, send a configuration request message to the GACS, obtain address information of a TACS, send the configuration request message to the TACS, and obtain configuration information from the TACS for automatic configuration.

The home gateway is adapted to: receive a DHCP Request message or a DHCP Inform message sent from the application terminal and send the address information of the GACS to the application terminal through a DHCP ACK message.

The GACS is adapted to: receive the configuration request message sent from the application terminal, obtain the address information of the TACS according to the configuration request message, and send the obtained address information of the TACS to the application terminal.

An embodiment of the present invention provides a home gateway. The home gateway includes:
a DHCP server module, adapted to send address information of a GACS to an application terminal through a DHCP ACK message after receiving a DHCP Request message or a DHCP Inform message sent from the application terminal.

An embodiment of the present invention provides a method for automatically configuring application terminals in a home network. The method includes:
exchanging information with a home gateway to obtain address information of a GACS and sending a configuration request message to the GACS; and
obtaining returned address information of a TACS from the GACS, sending the configuration request message to the TACS according to the obtained address information of the TACS, and obtaining configuration information from the TACS for automatic configuration.

In the technical solution provided in the preceding embodiments of the present invention, an application terminal obtains the URL of an ACS from a GACS. This ensures that the application terminal can securely obtain the URL of the ACS without increasing the complexity of the application terminal and avoids insecurity when the application terminal directly obtains the URL of the ACS from a public network.

### BRIEF DESCRIPTION OF THE DRAWINGS

FIG. 1 shows the networking of a system for automatically configuring application terminals in a home network in an embodiment of the present invention;

FIG. 2 shows a specific structure of a system for automatically configuring application terminals in a home network in an embodiment of the present invention; and

FIG. 3 shows a flowchart of a method for automatically configuring application terminals in a home network in an embodiment of the present invention.

### DETAILED DESCRIPTION OF THE INVENTION

Embodiments of the present invention provide a system, apparatus, and method for automatically configuring application terminals in a home network. For easy understanding, the following describes the system, apparatus, and method for automatically configuring application terminals in the home network in the embodiments of the present invention in detail with reference to the accompanying drawings.

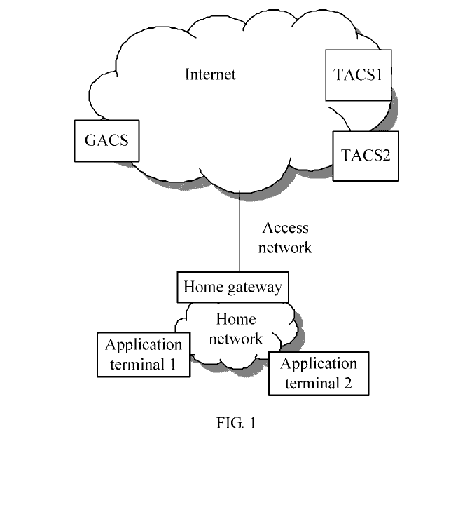

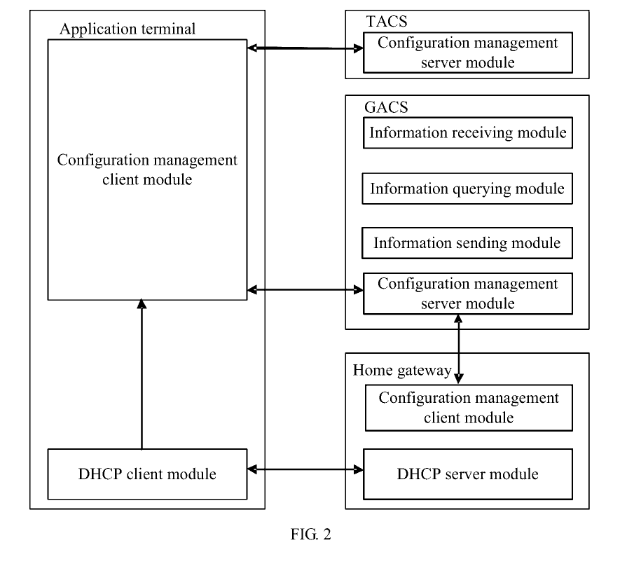

FIG. 1 shows the network of a system for automatically configuring application terminals in a home network in an embodiment of the present invention. As shown in FIG. 2, the system includes a GACS, a TACS, a home gateway, and an application terminal. To describe the embodiment clearer in FIG. 2, the system includes only one application terminal, and it is apparent that those skilled in the art may realize the embodiment with more application terminals.

The ACS automatically configures and manages its terminal devices according to a management protocol (such as TR069). Network operators and SPs may both deploy ACSs to automatically configure and manage the terminal devices within the management scopes of the ACSs.

The following takes the Customer Premises Equipment WAN Management Protocol (CWMP) (also referred to as TR069) for communication between a CPE and an ACS as an example to describe the functions of various modules in the system provided in an embodiment of the present invention.

The GACS is deployed by a network service provider (NSP) or an Internet service provider (ISP), and adapted to automatically configure and manage the home gateways of the NSP/ISP. In embodiments of the present invention, the GACS may also exchange messages with an application terminal through CWMP to send the URL of the TACS to the application terminal. Therefore, in addition to the modules that provide the configuration and management functions of the ACS, the GACS includes an information receiving module, an information querying module, and an information sending module.

The information receiving module is adapted to receive a configuration request message defined in TR069 from an application terminal. The configuration request message carries device identifier information.

The information querying module is adapted to query a locally stored table or the business support system (BSS)/operation support system (OSS) for relevant TACS information according to the device identifier information in the configuration request message.

The information sending module is adapted to obtain the URL information of the TACS and send the URL information to the application terminal through a configuration response message.

As defined in TR069, a device such as an application terminal in embodiments of the present invention should send an Inform message to the ACS if the device obtains the URL of the ACS after being started. The Inform message carries relevant information such as the device identifier. To obtain the configuration, the device needs to send a BOOTSTRAP event to the ACS through the Inform message. After receiving the BOOTSTRAP event, the ACS sends a Download message to the device to notify the device to obtain the configuration file. The Inform message carrying the BOOTSTRAP event can also be called a configuration request message.

If the received Inform message carries the BOOTSTRAP event, the GACS obtains the device identifier information from the Inform message and determines whether the device is a home gateway according to the device type information in the device identifier. If the device is not a home gateway, the GACS queries the database of the GACS or the BSS/OSS for the URL information of the TACS according to the device identifier information and sends the obtained URL information to the application terminal by using the SetParameterValues method.

The preceding Inform message, BOOTSTRAP event, and SetParameterValues method are defined in TR069. Their definitions may be different in other management protocols and the corresponding interaction processes may also be different. For example, as defined in TR069, after receiving an Inform message, the ACS should first return an InformResponse message and then operate on the terminal device by using the SetParameterValues method. The interaction mode may not be used in other management protocols. For example, the ACS directly carries the URL of the TACS in a message similar to the InformResponse message and does not need to send another message.

The TACS is deployed by an SP and adapted to automatically configure and manage the application terminals within its management scope through CWMP. One TACS can configure and manage several application terminals. After receiving a configuration request message sent through CWMP from an application terminal, the TACS returns corresponding configuration file information to the application terminal through CWMP.

The application terminal is adapted to exchange messages with the GACS through CWMP to obtain the URL information of the TACS according to the received URL information of the GACS from the home gateway. After that, the application terminal obtains the configuration file information from the TACS through CWMP according to the URL information of the TACS and uses the configuration file information for automatic configuration.

Specifically, the application terminal may include a DHCP client module and a configuration management client module.

The DHCP client module is adapted to obtain the IP address of the DHCP server from the network through DHCP and parse the URL of the ACS from the option in the DHCP ACK message sent from the home gateway. The application terminal interacts with the home gateway within the home network. Therefore, this process is regarded as secure.

The configuration management client module is adapted to interact with the ACS through CWMP. As defined in TR069, if the ACS changes the URL of the ACS of a terminal device, the terminal device should send an Inform message to the new ACS and be managed by the new ACS. With this mechanism, the application terminal first accesses the GACS obtained from the home gateway through DHCP. When the application terminal uses CWMP to interact with the GACS, the GACS sends the URL of the TACS to the application terminal. As a result, the application terminal obtains the URL of its own ACS. CWMP is based on the secure socket layer (SSL) protocol. Therefore, this process is secure.

The home gateway is adapted to allocate an IP address to the application terminal after receiving a DHCP Request message sent from the application terminal and carry the URL of the GACS in an option in a DHCP ACK message. The home gateway may obtain the URL of the GACS by using a secure method such as PPPoE, pre-configuration before delivery, or manual configuration by operators or users. According to the obtained URL of the GACS, the home gateway obtains the configuration from the GACS. In addition to the configuration management client module of the ACS, the home gateway includes a DHCP server module.

The DHCP server module is adapted to send the address information of the GACS to the application terminal through a DHCP ACK message after receiving a DHCP Request message or a DHCP Inform message sent from the application terminal.

Although TR069 defines the method for obtaining the URL of an ACS from the DHCP server through DHCP, the DHCP server that allocates an IP address to a home gateway is in the public network and thus it is insecure to obtain the URL of the ACS through DHCP. Therefore, the home gateway obtains the URL of the ACS by using other methods such as PPPoE, pre-configuration before delivery, and manual configuration by operators or users.

As shown in FIG. 1, TACS1 belongs to SP1 and automatically configures and manages the application terminals that use the services provided by SP1. One home network may include several application terminals that use the services provided by SP1. TACS2 belongs to SP2 and automatically configures and manages the application terminals that use the services provided by SP2. One home network may include several application terminals that use the services provided by SP2.

SP1 and SP2 may provide the same services. For example, SP1 and SP2 both provide VoIP services. SP1 and SP2 may also provide different services. For example, SP1 provides VoIP services and SP2 provides IPTV services. Therefore, application terminals 1 and 2 may be devices of the same type or devices of different types. In addition, one SP may provide several services. For example, the SP may provide VoIP and IPTV services at the same time.

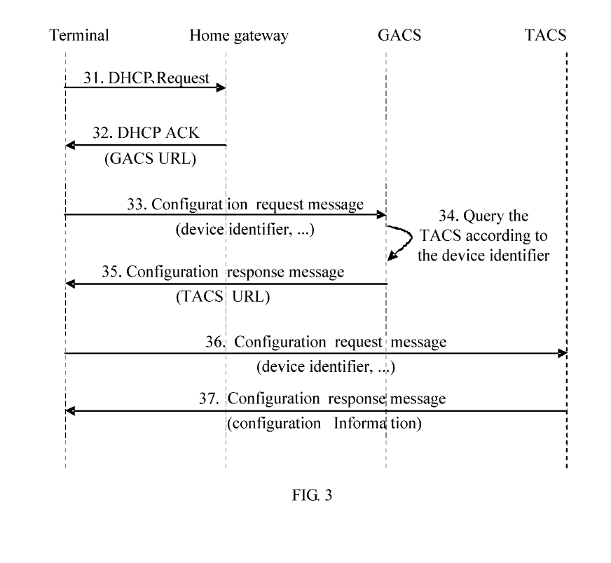

FIG. 3 shows a flowchart of a method for automatically configuring application terminals in a home network in an embodiment of the present invention. Suppose TR069 is used. The method may include the following steps:
Step 31: An application terminal uses DHCP to send a DHCP Request message to a home gateway to obtain its own IP address.

The devices in a home network may support different management specifications. For example, some support TR069 but others do not. To obtain the required information from the DHCP ACK message, the application terminal may carry certain special information in an option in the DHCP Request message. For example, in the embodiment of the present invention, the application terminal may carry the “dslforum.org” string in DHCP option 60 as required in TR069.
Step 32: After receiving the DHCP Request message, the home gateway allocates an IP address to the application terminal and adds the URL of the GACS to DHCP option 43 specified by TR069 in the DHCP ACK message.

As specified in DHCP, to obtain corresponding information from the DHCP server, the application terminal may send a DHCP Inform message to the DHCP server in step 31. Then the DHCP server returns a DHCP ACK message. This, however, affects step 32 and is not described further. Technical personnel in this field know the specific meanings and implementation methods.
Step 33: After receiving the DHCP ACK message, the application terminal obtains the URL of the GACS.

According to the obtained URL, the application terminal may use the Inform message defined in CWMP to access the GACS. The Inform message carries relevant device information such as the vendor information, device type, and device serial number. The relevant device information is called a device identifier and may identify a device uniquely. In addition, the Inform message carries the BOOTSTRAP event defined in TR069, indicating that the device needs to be configured. This message is called a configuration request message. The configuration request message is defined differently in other management protocols and the device identifier may also be different from that defined in TR069.
Step 34: After receiving the Inform message, the GACS finds that the device is not the home gateway according to the device type information in the Inform message, that is, the device is not actually managed by the GACS. In this case, according to the device identifier information, the GACS queries a locally stored table or the BSS/OSS for the URL information of the TACS.

Embodiments of the present invention require that the SP of the TACS provide relevant TACS information for the NSP/ISP of the GACS. The relevant TACS information includes the URL of the TACS and the device identifier information of the application terminal that uses the services provided by the SP, such as the vendor information, device type, and device serial number. In addition, the relevant TACS information should be stored to the GACS or the BSS/OSS of the NSP/ISP in a certain way. For example, the BSS/OSS of the NSP/ISP may provide a client for the SP. The SP loads the device identifier information of the application terminal and the URL of the TACS to the BSS/OSS system through the client. After that, the BSS/OSS transmits or does not transmit the information about the application terminal through the northbound interface of the GACS. In another way, the information about the terminals of the SP is stored only in the BSS/OSS of the SP. An interface, however, is available between the BSS/OSS of the NSP/ISP and the BSS/OSS of the SP. Through this interface, the GACS can query the URL of the TACS.
Step 35: The GACS sends the obtained URL of the TACS to the application terminal.

As specified in CWMP, the GACS may use the SetParameterValues method to change the URL of the TACS. Before using the SetParameterValues method, however, the GACS needs to return an InformResponse message to the application terminal. The SetParameterValues message that is triggered by the configuration request message sent from the application terminal and is sent out by the GACS is also a response to the configuration request message. Therefore, the differences in interactive messages defined in different protocols are also covered by the present invention.
Step 36: After receiving the URL of the new ACS from the GACS, the application terminal resends an Inform message to the new TACS.
Step 37: If the received Inform message carries the BOOTSTRAP event, the TACS uses the Download method defined in TR069 to notify the application terminal to obtain the configuration file. Thus, the application terminal obtains the corresponding configuration. Before using the Download method, the TACS needs to return an InformResponse message to the application terminal. The details about obtaining the configuration file are beyond the scope of the present invention and are not described further. If other configuration management protocols are used, however, the application terminal may obtain the configuration through a file or in another way in which the TACS gradually delivers parameter setting commands.

In the preceding steps, only one additional operation on the application terminal is required. That is, the application terminal needs to parse the URL information of the ACS from the DHCP ACK message in step 33. The subsequent steps are defined in CWMP. In addition, it is unnecessary to modify CWMP or add resources for the application terminal. In terms of the home gateway, all steps except step 32 are the same as what is specified in CWMP. In step 32, the home gateway needs to add the URL of the GACS to the option in the DHCP ACK message. The GACS needs to manage and query the TACS.

Through the preceding steps, the first step for automatically configuring the application terminal is finished within the home network. That is, the URL of the ACS is obtained within the home network. This avoids security problems in obtaining the URL of the ACS from the public network. Next, depending on the security of TR069 or other configuration management protocols, the application terminal obtains the URL of the TACS from the GACS, thus securely completing the process of automatically obtaining the TACS. Therefore, the security of the entire configuration process depends on the step for obtaining the URL of the GACS by the home gateway. In this step, the home gateway may securely obtain the URL of the GACS through PPPoE, pre-configuration before delivery, or manual setting. In a home network, only one home gateway is required but several application terminals for implementing various applications may be available.

Although the present invention has been described through exemplary embodiments, the present invention is not limited to such embodiments. It is apparent that those skilled in the art can make various modifications and variations such as replacing TR069 with SNMP V3 to the invention without departing from the spirit and scope of the invention. The invention is intended to cover the modifications and variations provided that they fall in the scope of protection defined by the claims or their equivalents.

What is claimed is:

1. An application terminal coupled to a home gateway in a home network, comprising:
a memory having program code stored therein; and
a processor coupled to the memory, wherein the processor when executing the program code is configured to
send a Dynamic Host Configuration Protocol (DHCP) request message or a DHCP Inform message to the home gateway, wherein the home gateway is associated with a Gateway Automatic Configuration Server (GACS) that has a different address from the home gateway in the home network,
obtain an address of the GACS from a DHCP ACK message sent by the home gateway,
send a configuration request to the GACS to obtain an address of an terminal automatic configuration server (TACS),
send the configuration request to the TACS based on the obtained address of the TACS, and
obtain configuration information from the TACS to configure the application terminal.

2. The application terminal of claim 1, further comprising:
a DHCP client configured to obtain an IP address of a DHCP server from the home network and parse the address of the GACS from the DHCP ACK message sent from the home gateway.

3. The application terminal of claim 1, wherein the address of the TACS for the application terminal is obtained by querying a locally stored table or a Business Support System or Operation Support System (BSS/OSS) for relevant information for the TACS according to device identifier information carried in the configuration request.

4. The application terminal of claim 1, wherein the configuration request is the DHCP Inform message carrying a BOOTSTRAP event, and a response to the configuration request is a response to the DHCP Inform message and the response is a SetParameterValues message.

5. A method for automatically configuring an application terminal in a home network, comprising:
exchanging, by the application terminal, information with a home gateway to obtain an address of a Gateway Automatic Configuration Server (GACS) that is different from address of the home gateway; and
sending, by the application terminal, a configuration request to the GACS, based on the obtained address of the GACS;
obtaining, by the application terminal, an address of a Terminal Automatic Configuration Server (TACS) GACS;
sending, by the application terminal, the configuration request to the TACS according to the obtained address of the TACS; and
obtaining, by the application terminal, configuration information from the TACS for automatic configuration.

6. The method of claim 5, wherein the exchanging information with the home gateway to obtain the address of the GACS comprises:
sending, by the application terminal, a Dynamic Host Configuration Protocol (DHCP) Request message or a DHCP Inform message to the home gateway; and
receiving, by the application terminal, the address of the GACS from the home gateway through a DHCP acknowledge (ACK) message after the home gateway receives the DHCP Request message or the DHCP Inform message.

7. The method of claim 5, wherein
the obtained address of the TACS is queried by the GACS after the GACS receives the configuration request, and is sent to the application terminal by the GACS.

8. The method of claim 7, wherein the obtained address of the TACS is queried for in a locally stored table or a business support system or an operation support system (BSS/OSS) by the GACS according to device identifier information carried in the configuration request sent from the application terminal, and is sent to the application terminal through a configuration response message.

9. A system, comprising:
an application terminal in a home network;
a home gateway coupled to the application terminal in the home network; and
a Gateway Automatic Configuration Server (GACS) associated with the home gateway in the home network,
wherein the application terminal is configured to
send a Dynamic Host Configuration Protocol (DHCP) request message or a DHCP Inform message to the home gateway,
obtain an address of the GACS from a DHCP ACK message sent by the home gateway, and
send a configuration request to the GACS to request an address of an terminal automatic configuration server (TACS),
wherein the GACS is configured to
receive the configuration request,
obtain an address of the TACS, and
send the address of the TACS to the application terminal,
wherein the application terminal is further configured to:
receive the address of the TACS from the GACS,
send the configuration request to the TACS based on the address of the TACS, and
obtain configuration information from the TACS to configure the application terminal.
